(19) United States
(12) Patent Application Publication
(10) Pub. No.: US 2005/0108909 A1
(43) Pub. Date: May 26, 2005

(54) Vehicle flag holder

(76) Inventor: Gregory F. Andersen, Long Branch, NJ (US)

Correspondence Address: LITMAN LAW OFFICES, LTD., P.O. BOX 15035 CRYSTAL CITY STATION, ARLINGTON, VA, 22215, US

(21) Appl. No.: 10/716,428

(22) Filed: Nov. 20, 2003

(51) Int. Cl. G09F 21/04

(52) U.S. Cl. 40/591

(57) ABSTRACT

A vehicle mounted flag holder constructed to be fastened to the rear of a vehicle, inserted into a conventional hitch receiver or to a bumper or bar hitch mount, depending upon how the vehicle is equipped. The flag holder has a provision for securely supporting a flagpole in a vertical position for display of a flag of substantial size while the vehicle is in motion or parked. The flag holder also has provision for rotating and securing the flagpole rearwardly to allow opening of a vehicle rear door or tail gate. Another embodiment supports two flagpoles, each displaying a flag. The flag holder is preferably made of steel or aluminum and the flagpoles are made of composite or contain spring material to allow for flex in high winds. The flagpole may be adjustable in height for a particular vehicle.

### BACKGROUND OF THE INVENTION

1. Field of the Invention

The present invention relates to flag holders. More particularly, the present invention relates to a flag holder for a vehicle attachable to a hitch receiver.

2. Description of the Related Art

The display of flags mounted on vehicles is well known. Such flags are typically mounted on a front fender by means of a bracket and are limited to a relatively small size. These flags typically indicate that a dignitary is riding inside the vehicle. Many patriotic persons, particularly during wartime, would like to display a larger flag of their country than is supportable on a typical flag-mounting bracket for fenders. It would be desirable to provide a mounting for flags to be placed on a vehicle which may safely support a relatively large flagpole and flag. It would also be desirable to provide a mounting which may readily be removed from the vehicle. Such a support would desirably fit within a conventional hitch receiver which is typically centrally mounted below the rear bumper of a vehicle. It would be desirable, in addition, to provide a, support which allows easy access to a rear door or tail gate of a vehicle without removing the flagpole mounted on the vehicle.

U.S. patent Publication No. 2003/0094473 A1, published May 22, 2003, for Moore, describes a flagpole holder for mounting in a hitch receiver of a vehicle.

U.S. patent Publication No. 2003/0071185 A1, published Apr. 17, 2003, for Casapulla, describes a flagpole holder for a trailer hitch receiver of a vehicle and also includes a ball type hitch which can be used with the flagpole holder in place.

U.S. Pat. No. 5,449,101, issued Sep. 12, 1995, to Van Dusen, describes a hitch receiver mounted rack which is adjustable between an upright position and a rearwardly angled position to-allow access to a vehicle door or tailgate.

U.S. Pat. No. 5,775,560, issued Jul. 7, 1998, to Zahn et al., describes a hitch receiver mounted carrying apparatus which is adjustable between an upright position and a rearwardly angled position.

U.S. Pat. No. 5,626,126, issued May 6, 1997, to McNulty, describes a hitch receiver mounted barbeque rack where the post holding the grill may be folded out at about a 45-degree rearward angle relative to the vehicle for use.

U.S. Pat. No. 6,062,451, issued May 16, 2000, to Lassanske et al., describes a hitch receiver mounted bicycle rack which is adjustable from vertical to a rearward angle.

None of the above inventions and patents, taken either singly or in combination, is seen to describe the instant invention as claimed. Thus a vehicle flag holder solving the aforementioned problems is desired.

### SUMMARY OF THE INVENTION

The vehicle flag holder of the present invention is constructed to be fastened to the rear of a vehicle, inserted into a conventional hitch receiver or to a bumper hitch mount, depending upon how the vehicle is equipped. The flag receiver includes a rectangular tongue insert portion which may be inserted and secured within the hitch receiver in a conventional manner, similar to the insertion of a ball hitch and tongue. Attached to the rear of the tongue insert is an upward opening flagpole receiver portion having vertical sidewalls and a rear wall extending at an upward, rearward angle relative to vertical.

The sidewalls support a hinge pin which extends through a bore in a flagpole near its lower end such that the pole may be rotated forward and back, the backward travel being limited by the angled back wall to about 45 degrees rotation from vertical. The sidewalls also support a removable snap lock securing pin by a first pair of corresponding bores spaced vertically upward from the hinge pin and which extends through a bore in the flagpole spaced upward from the hinge pin bore, the flagpole being secured in a vertical position for display when the snap lock pin is inserted. The sidewalls may also support the removable snap lock securing pin by a second pair of corresponding bores spaced to the rear of the first pair of bores, the second pair of bores being so located that the flagpole is secured at an upward, rearward angle of about 45 degrees from vertical such that when the flagpole is rotated toward the rear to rest against the angled rear wall of the pole receiver portion, the flagpole may be secured in place by the snap lock securing pin. The pole is secured in this position to allow the rear door or tail gate of the vehicle to swing to the open position without interference with the flagpole.

A vertical bore is provided in the tongue insert near its front end for fastening to a bumper hitch mount by means of a hitch bolt. This arrangement takes advantage of a bumper hitch mount vertical bore by which a ball hitch is normally mounted.

Another embodiment provides a cross beam centrally attached to the tongue insert as inserted into a hitch receiver, the cross beam extending laterally along the bumper of the vehicle. Separate flagpole receivers as described above may be attached at opposite ends of the cross beam to support a total of two flagpoles for displaying two flags from the vehicle.

Accordingly, it is a principal object of the invention to provide a mounting or holder for securely holding a flagpole and flag of substantial size by a vehicle for flag display during driving or parking of the vehicle.

It is another object of the invention to provide a holder as above which employs an existing hitch system mounted on the vehicle.

It is a further object of the invention to provide a holder as above which may be rotated back and away from vertical and secured to display the flag at an angle and allow for opening of a vehicle rear door or tail gate.

Still another object of the invention is to provide a holder as above which may securely hold two flagpoles for display of two flags.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a vehicle flag holder according to the present invention.

FIG. 2 is a detail view of the vehicle flag holder of FIG. 1.

FIG. 3 is an explodes view of the vehicle flag holder of FIG. 1.

FIG. 4 is depiction of a prior art bumper hitch mount and ball hitch.

FIG. 5 is a detail view of the vehicle flag holder of FIG. 1 as mounted on a bumper hitch mount as in FIG. 4.

FIG. 6 is an environmental, perspective view of another embodiment of the inventive flag holder wherein two flag receivers as in FIG. 1 are supported by the flag holder.

FIG. 7 is a detail view of the embodiment of FIG. 6.

Similar reference characters denote corresponding features consistently throughout the attached drawings.

### DETAILED DESCRIPTION OF THE PREFERRED EMBODIMENTS

The present invention is a vehicle mounted flag holder constructed to be fastened to the rear of a vehicle, inserted into a conventional hitch receiver or to a bumper hitch mount, depending upon how the vehicle is equipped. The flag holder has a provision for securely supporting a flagpole in a vertical position for display of a flag of substantial size while the vehicle is in motion or parked. The flag holder also has provision for rotating and securing the flagpole rearwardly to allow opening of a vehicle rear door or tail gate. Another embodiment supports two flagpoles, each displaying a flag.

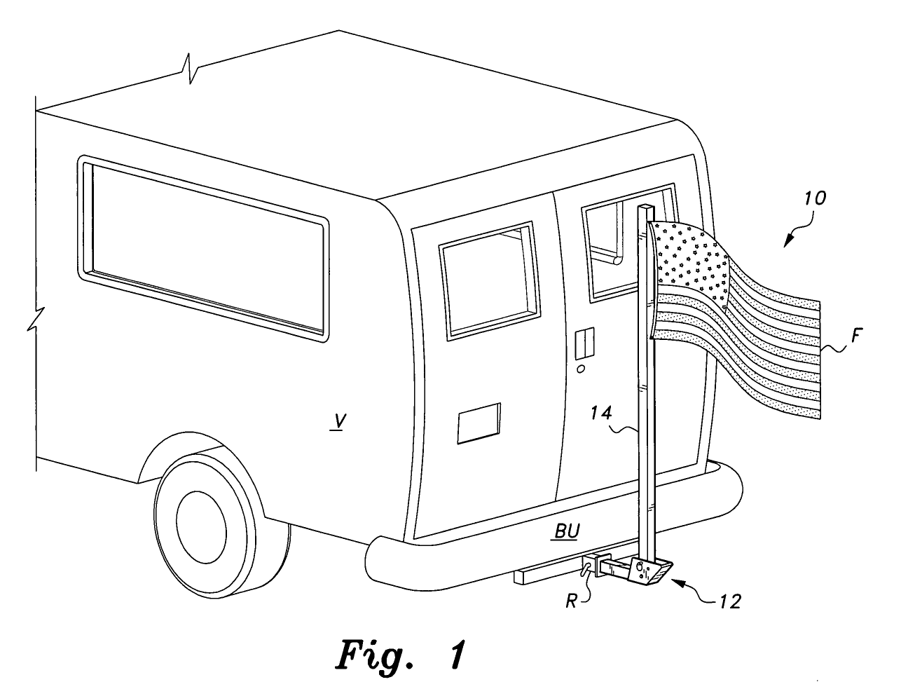

Referring to FIG. 1, there is shown an environmental, perspective view of a first embodiment of the invention as mounted to a recreational vehicle having a conventional hitch receiver. Flag holder system 10 is mounted on vehicle V having rear bumper BU and hitch receiver R wherein flagpole receiver 12 supports flagpole 14 in a vertical position for displaying flag F.

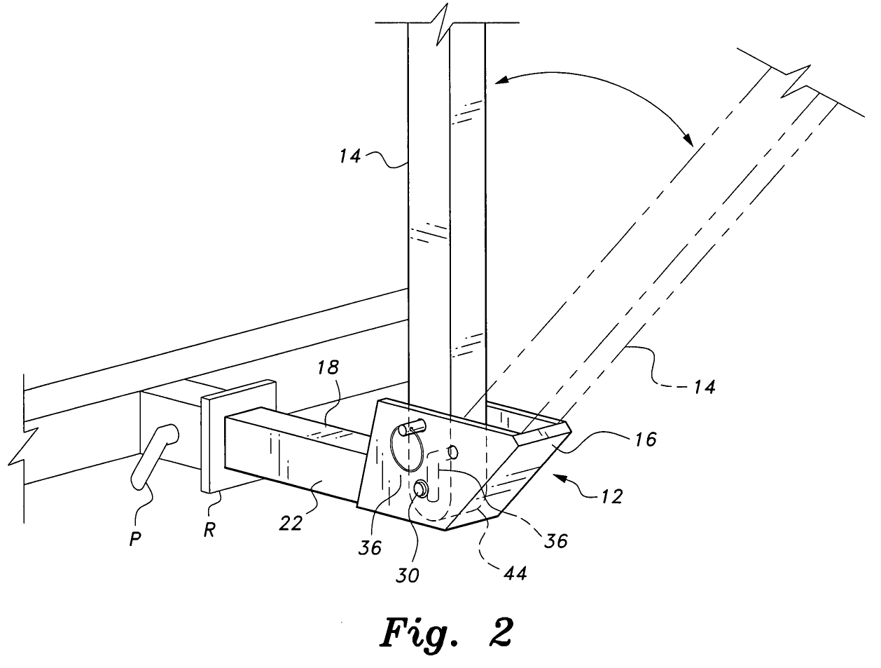

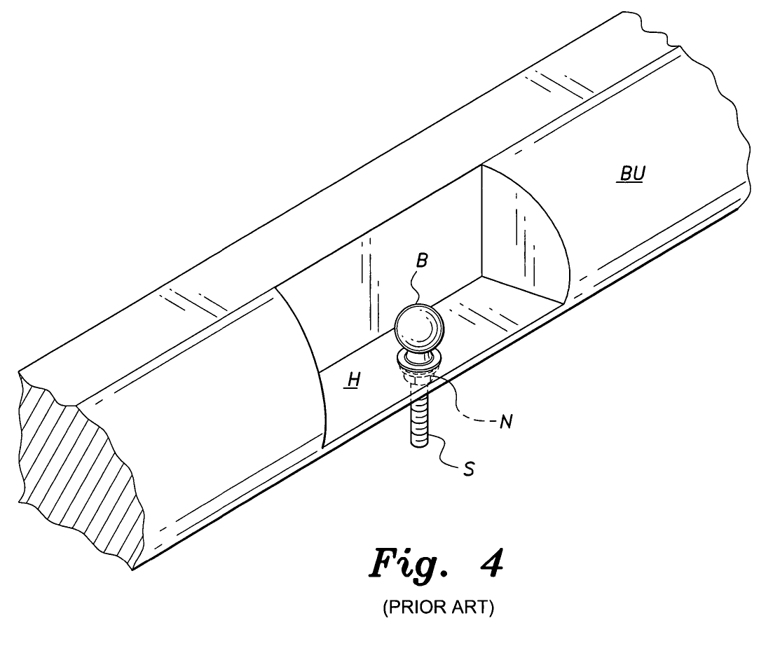

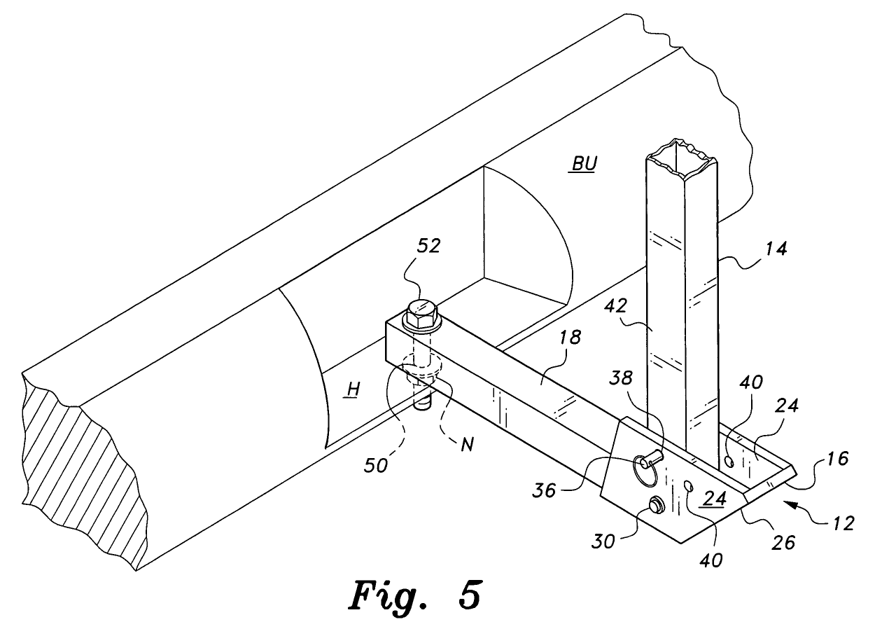

Referring to FIGS. 2-5, there are shown detail and exploded views of the inventive flag holder system 10 of FIG. 1 wherein flagpole receiver 12 supports flagpole 14 in upward opening pole receiving portion 16 connected with tongue insert portion 18 which is inserted into hitch receiver R. Flagpole receiver 12 is inserted and removably secured in hitch receiver R by receiver pin P inserted through the sidewalls of receiver R and tongue receiver pin bores 20 extending through sidewalls 22 of tongue insert portion 18, pin P being secured by clip C. Tongue insert portion 18 has a distal end for insertion within receiver hitch receiver R and a rear proximate end to which receiver 16 is mounted. Receiver 16 has opposed sidewalls 24 attached to the proximate end of tongue insert portion 18, as by welding, between which is mounted angled end wall 26 forming the rear end of the flagpole receiver 12. End wall 26 is angled upward and rearward relative to the vehicle V, preferably at an angle of about 45 degrees relative to the vertical. Side walls 24 have laterally aligned pivot pin receiving bores 28 located in their lower portion bore receiving pivot pin 30 secured by clip 32 against washer 34. Side walls 24 have laterally aligned upright positioning bores 38 located in their upper portions and spaced vertically above pivot pin receiving bores 28 for receiving snap lock securing pin 36 having detent 37. Side walls 24 have laterally aligned angled positioning bores 40 spaced rearwardly from upright positioning bores 38. Flagpole 14 has sides 42 and a rounded end 44 through which a lateral pole pivot throughbore 28 extends. A lateral pole positioning throughbore 48 is axially spaced upward from throughbore 44 and extends through pole 14 parallel with throughbore 44.

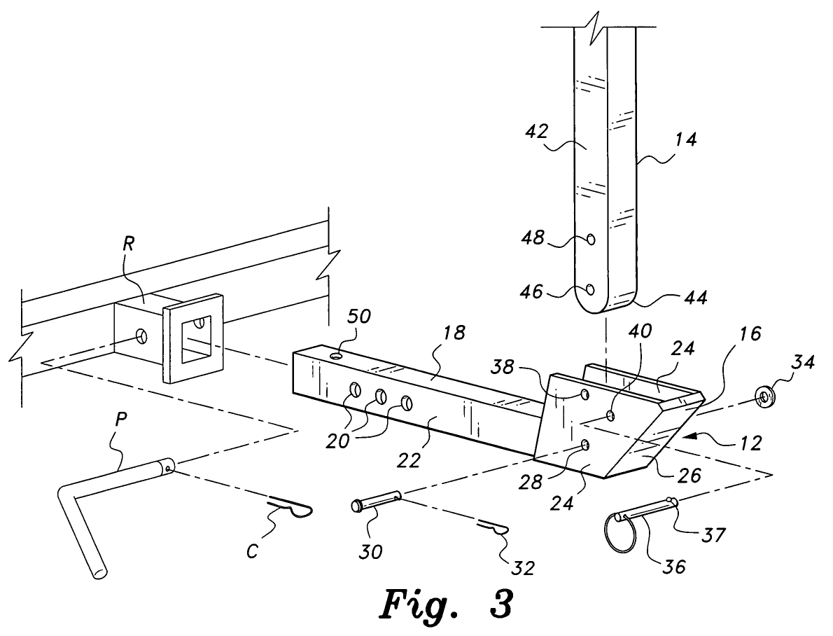

As best seen in FIGS. 2 and 3, flagpole 14 may be rotated from a secured vertical position to a secured angled position by pulling to remove snap lock securing pin 36 from upright position bores 38 in side walls 24 rotating flagpole 14 rearward around pivot pin 30 until it rests against end wall 16, and the inserting snap lock securing pin 36 through angled position bores 40 and pole position throughbore 48, thereby securing pole 14 in an angled position. The pole 14 may be returned to a vertical position by reversing these steps.

Referring more particularly to FIGS. 3, 4, and 5, vehicle V has a rear bumper BU having a centrally located bumper hitch mount H (shown as a flat portion of rear bumper BU). A bar type hitch mount H extending from under the vehicle in a conventional manner may be used as an equivalent mounting. A hitch ball B is normally secured through a vertical bore in the hitch mount and secured by a nut N under the mount as turned on the threaded mounting stud S. A vertical bumper mount bore 50 in tongue insert portion 18 of flagpole receiver 12 near its distal end allows flagpole receiver 12 to be mounted in place of hitch ball B by insertion of hitch mount bolt 52 downward through bumper mount bore 50 and securing in place by nut N. Preferably, washers are placed between the nut N and head of bolt 52 and the lower and upper surfaces of tongue insert portion 18.

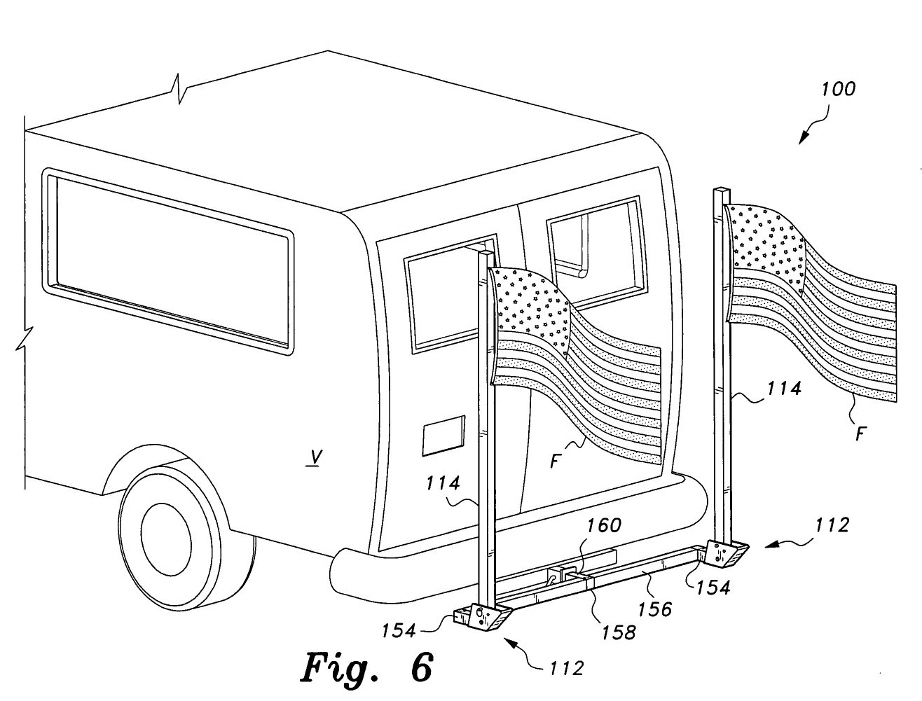

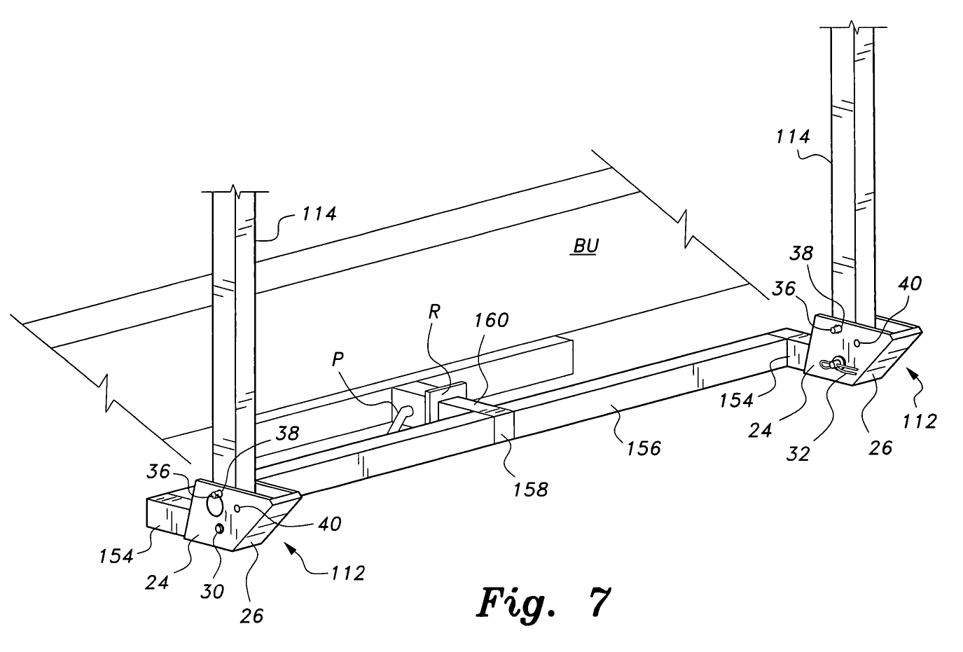

Referring to FIGS. 6 and 7 there is shown an environmental, perspective view and a detail view of another embodiment 100 of the invention where two flagpoles are supported by the vehicle V for displaying two flags F. In this embodiment two flagpole receivers 112 are connected by outer tongue portions 154 to opposing ends of a cross beam 156 extending laterally along the bumper BU of vehicle V. Cross beam 156 is supported at its center point 158 by inner tongue insert portion 160 which is removably inserted into hitch receiver R and secured by receiver pin P. Each flagpole 114 is rotatable and securable in a vertical position and a rearward angled position within the pole receiving portions of flagpole receivers 112 in an identical manner to that described above in which a single flagpole is supported in vertical and angled positions (see detailed description above relating to FIGS. 1-4). This embodiment has the advantage of providing clear vision back for the driver. Of course, any desired number of flag holders 112 may be mounted on cross beam 156 for displaying an equal number of flags on flagpoles 114 and such embodiments are within the scope of the claims. Also, cross beam 156 may be used to offset a single flag holder 112 to improve rear vision back for the driver.

The flag holders of the present invention are preferably constructed of steel or aluminum, however other appropriate materials may be employed in their construction. The flagpole and holder may be constructed to fit any existing commercial 1¼″ or 2″ receiver style type II, IV, or V trailer hitch. The receiver style hitch is made by manufacturers such as Reese, Draw-Tight, and Putnam. The flagpoles are preferably from about 4 to 6 feet in length and are made of graphite or fiberglass composite that allow the pole to flex in high winds. The flagpoles may have spring mount portion at their lower end as is known in the antennae arts to allow flexing in wind and avoid damage from collision. The flagpoles are preferably of such a length as to not extend above the cab of the vehicle to minimize collision with tree limbs or the like. The flagpoles may be adjustable in height such as by “telescoping” in a well known manner to allow transfer between vehicles of different heights.

Any flag or combination thereof may be displayed by the present invention.

It is to be understood that the present invention is not limited to the embodiments described above, but encompasses any and all embodiments within the scope of the following claims.

1. A vehicle flag holder for mounting in a vehicle rear hitch receiver comprising:
at least one flagpole receiver having a first upward-opening pole receiving portion and a tongue mount portion having such cross section as to be received within the vehicle hitch receiver and removably secured therein;
said tongue mount portion having a distal end and a proximate end, said distal end being receivable within the vehicle hitch receiver, said pole receiving portion being attached to and extending outward from said proximate end of said tongue mount portion;
said pole receiving portion having opposed vertical sidewalls defining corresponding aligned pivot pin receiving bores located at respective lower portions thereof and further defining corresponding respective upright positioning bores located at respective upper portions thereof and vertically spaced from said pivot pin receiving bores;
an elongated flagpole extending upwardly from said pole receiving portion, said flagpole having a lower end portion defining a pivot pin throughbore and a pole positioning throughbore spaced upward from said pivot pin throughbore;
a pivot pin extending through said pivot pin receiving bores and said pole pivot throughbore for rearward pivotal mounting of said flagpole to said pole receiving portion; and
a securing pin removably mounted in and extending through said upright positioning bores and said pole positioning throughbore.

2. The vehicle flag holder of claim 1, wherein said tongue insert portion of said pole receiver is rectangular in cross section and of such size as to slidingly fit within the hitch receiver, said tongue insert portion defining at least one laterally extending receiving bores for removably receiving a receiver pin for removably securing said vehicle flag holder to the hitch receiver.

3. The vehicle flag holder of claim 2, said opposed vertical sidewalls of said pole receiving portion further defining respective corresponding aligned angled positioning bores space rearwardly from said upright position bores, said angled positioning bores and said pole positioning throughbore removably receiving said securing pin such that said flagpole is mountable at an upward, rearward angle relative to the vehicle.

4. The vehicle flag holder of claim 3, further comprising an angled end wall mounted between said sidewalls at the respective ends thereof, said angle end wall extending at said upward, rearward angle relative to the vehicle so as to provide support for said flagpole when mounted at said angle.

5. The vehicle flag holder of claim 4, wherein said upward, rearward angle is about 45 degrees from vertical.

6. The vehicle flag holder of claim 4, wherein said flagpole has a rounded lower end and is rotatable on said pivot pin between a vertical position and said upward, rearward angle and alternatively securable at said vertical position and at a position extending at said upward, rearward angle by said securing pin.

7. The vehicle flag holder of claim 6, wherein said securing pin is a snap lock securing pin having a detent.

8. The vehicle flag holder of claim 2, wherein said hitch receiver is one of a 1¼″ or 2″ receiver for a type II, IV, or V trailer hitch and said tongue insert portion is of such sized as to slideably fit within a respective one of the hitch receivers.

9. The vehicle flag holder of claim 1, wherein said flagpole is approximately 4 to 6 feet in length.

10. The vehicle flag holder of claim 4, further comprising
at least a second pole receiver portion, said tongue insert portion comprising a single inner tongue portion, two outer tongue portions and a cross beam having opposing ends and extending laterally along the rear of the vehicle and having a central point attached to said single inner tongue portion, said outer tongue portions being attached to and extending rearwardly from said opposing ends of said cross beam;
said vehicle flag holder further comprising a second pole receiving portion, said first pole receiving portion being attached to and extending rearward from one of said outer tongue portions and said second pole receiving portion being attached to and extending rearward of the other of said outer tongue portions; and
a first and a second flagpole removably mounted in said first and second pole receiving portions, respectively.

11. The vehicle flag holder of claim 10, wherein said upward, rearward angle is about 45 degrees from vertical.

12. The vehicle flag holder of claim 10, wherein said flagpole has a rounded lower end and is rotatable on said pivot pin between a vertical position and said upward, rearward angle and alternatively securable at said vertical position and a position extending at said upward, rearward angle by said securing pin.

13. The vehicle flag holder of claim 12, wherein said securing pin is a snap lock securing pin having a detent.

14. The vehicle flag holder of claim 10, wherein there are a plurality of said pole receivers located along said cross beam supporting an equal plurality of flagpoles.

15. The vehicle flag holder of claim 4, said vehicle having a bumper hitch mount for mounting a hitch ball, said tongue insert portion defining a vertically oriented bumper mount bore spaced outward from said distal end, and further comprising a hitch mount bolt removably extending through said bumper mount bore and the bumper hitch mount of the vehicle.

16. The vehicle flag holder of claim 10, said vehicle having a bumper hitch mount for mounting a hitch ball, said tongue insert portion defining a vertically oriented bumper mount bore spaced outward from said distal end, and further comprising a hitch mount bolt removably extending through said bumper mount bore and the bumper hitch mount of the vehicle.

17. The vehicle flag holder of claim 1, further comprising a flag mounted on said flagpole.

18. The vehicle flag holder of claim 10, further comprising a flag mounted on each said flagpole.

19. The vehicle flag holder of claim 1, wherein said flagpole is made of composite material so as to allow flexing in high winds.
